(19) United States
(12) Patent Application Publication
(10) Pub. No.: US 2005/0014515 A1
(43) Pub. Date: Jan. 20, 2005

(54) Mobile communication terminal, handover control method, and handover control program

(75) Inventor: Koji Suzuki, Kanagawa (JP)

Correspondence Address: McDERMOTT, WILL & EMERY, 600 13th Street, N.W., Washington, DC, 20005-3096, US

(73) Assignee: MATSUSHITA ELECTRIC INDUSTRIAL CO., LTD.

(21) Appl. No.: 10/870,182

(22) Filed: Jun. 18, 2004

(30) Foreign Application Priority Data
Jun. 18, 2003 (JP) P. 2003-173451

(51) Int. Cl. H04Q 7/20

(52) U.S. Cl. 455/456.1

(57) ABSTRACT

A total number of unnecessary handover control operations is reduced.

Distances between a mobile communication terminal and respective plural base stations located at peripheral areas thereof, a move direction and a move speed of the mobile communication terminal are obtained by a positional information detecting unit 121, a distance calculating unit 122, and a move direction and move speed calculating unit 123. Furthermore, conditions of fading deteriorations in the respective plural and peripheral base stations are acquired by a transfer path quality detecting unit 124. Then, an offset value with respect to a reception level as to each of the plural and peripheral base stations is calculated by way of an offset calculate unit 125 based upon the various sorts of parameters which have been obtained. Then, such a base station which constitutes a handover destination is selected by a handover destination selecting unit 126 based upon the offset values with respect to the plural and peripheral base stations which have been calculated, and the reception signal levels with respect to the plural and peripheral base stations.

### BACKGROUND OF THE INVENTION

1. Field of the Invention

The present invention is related to a mobile communication terminal equipped with a function for selecting a base station of a connection destination when an handover control operation is carried out in a mobile communication system, and also, is related to a handover control method and a handover control program.

2. Description of the Related Art

Conventionally, in a mobile communication system, when a mobile communication terminal operated under communication operation is moved among cells, a so-called “handover” control operation is carried out, namely this mobile communication terminal switches base stations of connection destinations. In the case that a mobile communication terminal performs a handover control operation, the mobile communication terminal measures reception qualities of electromagnetic waves which are transmitted from a plurality of base stations located at peripheral areas of this mobile communication terminal, and selects such a base station whose electromagnetic wave is transmitted under most stable condition at a reception signal level higher than, or equal to a predetermined signal level, and then switches a connection destination to this base station.

In order that such a handover control operation is carried out, the below-mentioned conventional techniques related to the handover control method have been proposed. For example, in one conventional handover control method, a threshold value of a handover control operation is changed in response to a reception power level so as to delete unnecessary handover control operations (refer to, for example, Japanese Laid-open patent Application No. 2000-102057).

Also, in another conventional handover control method, while the GPS system is employed so as to acquire positional information of peripheral base stations, distances between these peripheral base stations and the own mobile communication terminal are measured, and then this mobile communication terminal performs a handover control operation with respect to a proper cell (refer to, for example, Japanese Laid-open patent Application No. 2002-199428).

Since reception qualities of electromagnetic waves which are transmitted from a plurality of base stations located at a peripheral area of the own mobile communication terminal are measured so as to select a desirable base station in accordance with the conventional handover control method, generally speaking, such a base station is selected which is located at the nearest position with respect to the own mobile communication terminal. However, for example, in such a case that a mobile communication terminal is moved in a high speed, and/or in the case that even when a mobile speed of the mobile communication terminal is not so high, a diameter of a cell is small, a frequency degree of handover operations is increased, which causes a process load to be increased with respect to the mobile communication terminal.

Also, a judgment of a handover control operation based upon only reception qualities cannot be always carried out in such a case that while a mobile communication terminal is moved, a reception signal level is rapidly varied due to the reason of a condition change of a transfer path, which is caused by a fading phenomenon. This fading phenomenon may occur, because of an adverse influence caused by buildings located around the signal reception route, and/or an adverse influence caused by moving of a mobile communication terminal. For instance, even when a mobile communication terminal is located at a position close to a base station and thus a reception signal level is high, this high reception level is rapidly varied due to moving of the mobile communication terminal and adverse influences caused by buildings located around this mobile communication terminal, so that an unnecessary handover operation may occur.

Conversely, even when a mobile communication terminal is located at a far position with respect to a base station, and thus a reception signal level is low, if a condition as a communication route is better due to no building, then this base station should be originally selected as a handover destination. However, this remote base station is not selected as the handover destination. When a communication condition with respect to a cell under communication is rapidly changed, a handover control operation cannot be carried out at proper timing, which may cause an occurrence of out of synchronous state, and/or an occurrence of an interruption of a communication line.

### SUMMARY OF THE INVENTION

The present invention has been made to solve the above-described problems of the conventional techniques, and therefore, has an object to provide a mobile communication terminal, a handover control method, and a handover control program, which are capable of reducing a total number of unnecessary handover control operations.

A mobile communication terminal of claim 1 is featured by such a mobile communication terminal for communicating via wireless communication lines with respect to a plurality of base stations located at peripheral areas of the own mobile communication terminal, comprising: positional information detecting means for acquiring positional information of a peripheral base station operated under connection condition so as to detect a position of the own terminal; distance calculating means for calculating a distance between the position of the own terminal and each of the plural base stations; move direction and move speed detecting means for detecting both a move direction and a move speed of the own terminal based upon the positional information of the own terminal; transfer path quality detecting means for detecting a transfer path quality between the own terminal and each of the plural base stations; offset calculating means for calculating an offset value for a reception signal level with respect to each of the plural base stations based upon the distance between the own terminal and each of the plural base stations, and both the move direction and the move speed of the own terminal and also the transfer path quality; and handover destination selecting means for selecting a base station which constitutes a handover destination based upon the offset values calculated every the base station and the reception signal level every the base station.

With employment of the above-described embodiment, the offset value for the reception signal level with respect to each of the plural base stations is calculated based upon the distance between the own terminal and each of the plural base stations, and both the move direction and the move speed of the own terminal and also the transfer path quality; and the base station which constitutes the handover destination is selected based upon the offset values calculated every the base station and the reception signal level every the base station. As a result, a total number of the unnecessary handover control operations can be reduced. As a consequence, the power consumption of the mobile communication terminal can be reduced, and the load given to the entire wireless communication system can be reduced.

A mobile communication terminal of claim 2 is featured by that in the mobile communication terminal recited in claim 1, the positional information detecting means detects the position of the own terminal based upon latitude and longitude information transmitted from the base station.

In accordance with the above-described arrangement, since the distances between the position of the mobile communication terminal and the respective positions of the plural and peripheral base stations are calculated, the base station of the optimum handover destination can be selected, so that a total number of unnecessary handover control operations can be reduced.

A mobile communication terminal of claim 3 is featured by that in the mobile communication terminal recited in claim 1, or claim 2, the move direction and move speed detecting means calculates both the move speed and the move direction of the own terminal based upon a ratio of temporal changes to the position of the own terminal calculated by the positional information calculating means.

In accordance with the above-described arrangement, since both the move speed and the move direction of the mobile communication terminal are obtained, the base station of the optimum handover destination can be selected, so that a total number of unnecessary handover control operations can be reduced.

A mobile communication terminal of claim 4 is featured by that in the mobile communication terminal recited in any one of claim 1 to claim 3, the transfer path quality detecting means detects the transfer path quality from a degree of fading deteriorations which is calculated based upon dispersion of a reception signal and a path number by multipath when the wireless signal transmitted from the base station is received.

In accordance with the above-explained arrangement, since the fading deterioration is detected so as to grasp the condition of the transfer path, such abase station which can be hardly and adversely influenced by the fading phenomenon can be selected, so that the stable communication condition can be continuously maintained.

A mobile communication terminal of claim 5 is featured by that in the mobile communication terminal recited in claim 4, the offset calculating means calculates a minus offset value with respect to such a base station that a fading deterioration thereof is large. Also, a mobile communication terminal of claim 6 is featured by that in the mobile communication terminal recited in claim 4, the offset calculating means calculates a minus offset value with respect to such a base station that a fading deterioration thereof is small.

In accordance with the above-described arrangements, for instance, even when a distance between the own terminal and such a base station is short and reception level is high, the handover control unit 120 applies the offset value along the minus direction to a reception level of the base station in which the reception level is easily fluctuated by the fading phenomenon, whereas even when a reception level is low, the handover control unit 120 applies the offset value along the plus direction to a reception level of such a base station that a condition as a communication route is better. As a consequence, the handover control unit 120 deletes such a base station which does not preferably constitute a desirable base station of a handover destination from handover candidates, and can readily select such a base station whose communication route is set to a better condition, so that a communication operation can be established between the own terminal and the base station whose communication route is set to the better condition in order that out of synchronous state does not occur, and a line interruption does not occur.

A mobile communication terminal of claim 7 is featured by that in the mobile communication terminal recited in any one of claim 1 to claim 6, the handover destination selecting means selects the base station which constitutes the handover destination based upon the offset values which have been set to the respective base stations and the reception signal levels of the wireless signals transmitted from the base stations.

In accordance with the above-explained arrangement, since the base station which constitutes the handover destination is selected based upon the offset values which have been set to the respective base stations and the reception signal levels of the wireless signals transmitted from the base stations, the base station of the optimum handover destination can be selected, so that a total number of the unnecessary handover control operations can be reduced.

A handover control method of claim 8 is featured by such a handover control method in which while a mobile communication terminal is moved among plural base stations, an optimum base station for communication operation is successively selected in connection with the movement of the mobile communication terminal, comprising: a positional information detecting step for acquiring positional information of a peripheral base station operated under connection condition with the mobile communication terminal so as to detect a position of the mobile communication terminal; a distance calculating step for calculating a distance between the position of the mobile communication terminal and each of the plural base stations; a move direction and move speed detecting step for detecting both a move direction and a move speed of the mobile communication terminal based upon the positional information of the mobile communication terminal; a transfer path quality detecting step for detecting a transfer path quality between the mobile communication terminal and each of the plural base stations; an offset calculating step for calculating an offset value with respect to a reception signal level with respect to each of the plural base stations based upon the distance between the mobile communication terminal and each of the plural base stations, and both the move direction and the move speed of the mobile communication terminal and also the transfer path quality; and a handover destination selecting step for selecting a base station which constitutes a handover destination based upon the offset values calculated every the base station and the reception signal level every the base station. Also, a handover control program of claim 9 is featured by such a handover control program in which while a mobile communication terminal is moved among plural base stations, an optimum base station for communication operation is successively selected in connection with the movement of the mobile communication terminal, and in which the handover control program causes a computer to execute: a positional information detecting step for acquiring positional information of a peripheral base station operated under connection condition with the mobile communication terminal so as to detect a position of the mobile communication terminal; a distance calculating step for calculating a distance between the position of the mobile communication terminal and each of the plural base stations; a move direction and move speed detecting step for detecting both a move direction and a move speed of the mobile communication terminal based upon the positional information of the mobile communication terminal; a transfer path quality detecting step for detecting a transfer path quality between the mobile communication terminal and each of the plural base stations; an offset calculating step for calculating an offset value with respect to a reception signal level with respect to each of the plural base stations based upon the distance between the mobile communication terminal and each of the plural base stations, and both the move direction and the move speed of the mobile communication terminal and also the transfer path quality; and a handover destination selecting step for selecting abase station which constitutes a handover destination based upon the offset values calculated every the base station and the reception signal level every the base station.

In accordance with the above-described controlling steps, the offset value for the reception signal level with respect to each of the plural base stations is calculated based upon the distance between the mobile communication terminal and each of the plural base stations, and both the move direction and the move speed of the mobile communication terminal and also the transfer path quality; and such a base station which constitutes the handover destination is selected based upon the offset values calculated every the base station and the reception signal level every the base station. As a result, a total number of the unnecessary handover control operations can be reduced. As a consequence, the power consumption of the mobile communication terminal can be reduced, and the load given to the entire wireless communication system can be reduced.

### BRIEF DESCRIPTION OF THE DRAWINGS

FIG. 1 is a block diagram for indicating an arrangement of a mobile communication terminal according to an embodiment mode of the present invention.

FIG. 2 is a diagram for representing an example of reception levels of peripheral base stations, which are recorded on a reception level recording unit of the mobile communication terminal of FIG. 1.

FIG. 3 is a diagram for showing an example of peripheral base station information which is recorded on a peripheral base station recording unit of the mobile communication terminal of FIG. 1.

FIG. 4 is a diagram for representing a wireless communication system with employment of the mobile communication terminal of FIG. 1.

FIG. 5 is a flow chart for explaining operations of the mobile communication terminal employed in the wireless communication system of FIG. 4.

### DESCRIPTION OF THE PREFERRED EMBODIMENTS

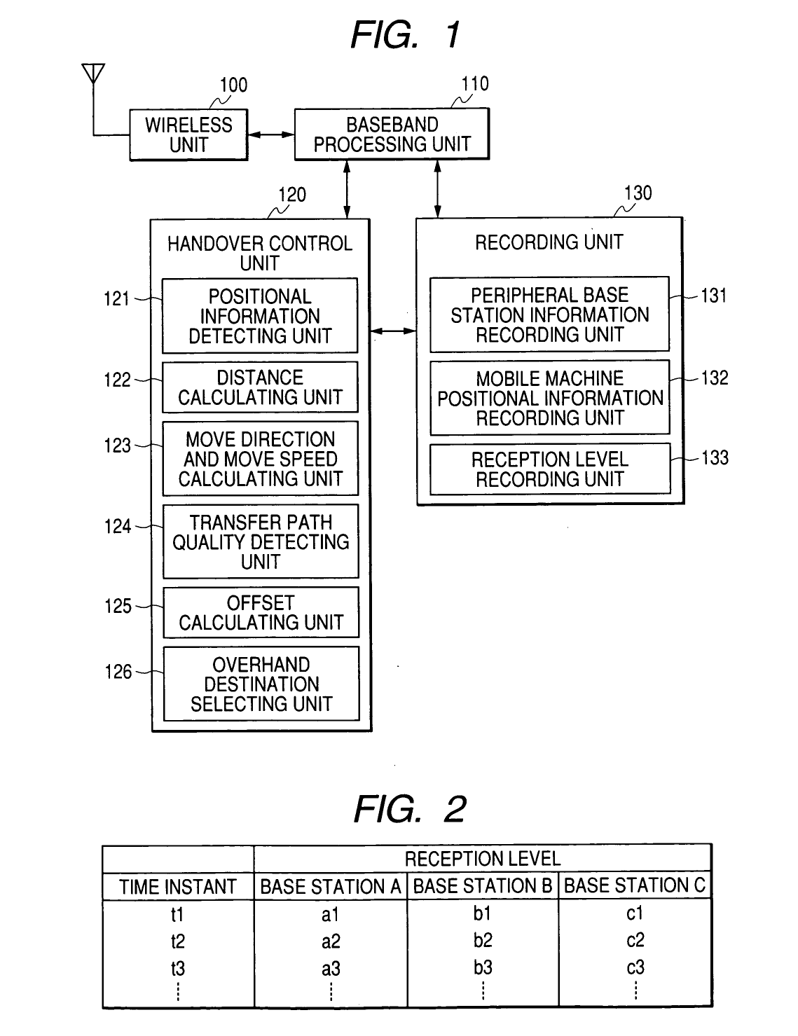

Referring now to drawings, various embodiment modes of the present invention will be described. FIG. 1 is a block diagram for schematically showing an arrangement of a mobile communication terminal according to an embodiment mode of the present invention. As represented in FIG. 1, the mobile communication terminal according to this embodiment mode is provided with a wireless unit 100, a baseband process unit 110, a handover control unit 120, and a recording unit 130. The handover control unit 120 is equipped with a positional information detecting unit 121, a distance calculating unit 122, a move direction and move speed calculating unit 123, a transfer path quality detecting unit 124, an offset calculating unit 125, and a handover selecting unit 126.

The recording unit 130 is equipped with a peripheral base station information recording unit 131, a mobile machine positional information recording unit 132, and a reception level recording unit 133. The peripheral base station information recording unit 131 records thereon information as to a plurality of peripheral base stations in connection with movement of the own mobile communication terminal. The mobile machine positional information recording unit 132 records thereon positions in connection with movement of the own mobile communication terminal. The reception level recording unit 133 records thereon reception signal levels when wireless signals transmitted from a plurality of peripheral base stations are received.

The wireless unit 100 performs a wireless communication between a base station (not shown) and the wireless unit 100. The baseband processing unit 110 processes a reception signal supplied from the wireless unit 100 so as to convert this reception signal into demodulated data having a predetermined format. The positional information detecting unit 121 acquires positional information of peripheral base stations under connection condition so as to detect positional information of the own terminal. The distance calculating unit 122 calculates a distance between the positional information of the own terminal and the relevant base station. The move direction and move speed calculating unit 123 calculates a move direction of the own terminal based upon the own terminal apparatus, and calculates a move speed of the own terminal based upon a temporal change of the own terminal position. The transfer path quality detecting unit 124 detects transfer qualities between the own terminal and each of the plural peripheral base stations.

In this embodiment, in order to judge transfer qualities, fading deteriorations are employed. The transfer path quality detecting unit 124 records reception signal levels in the case that wireless signals transmitted from a plurality of peripheral base stations are received, and calculates a degree of fading deterioration based upon dispersion of the recorded reception signal levels and also a path number by multipath. Since fading deteriorations are detected so as to grasp conditions of transfer paths, namely to grasp transfer qualities, such a base station which can be hardly influenced by a fading phenomenon can be selected in a top priority, and stable communication conditions can be continuously maintained.

The offset calculating unit 125 calculates a offset value with respect to a reception signal level every base station based upon a distance between the own terminal and each of the plurality of peripheral base stations, a transfer quality detection result, a move direction of the own terminal, and a move speed of the own terminal. In this case, the offset calculating unit 125 calculates a minus offset value with respect with such a base station having a large fading deterioration, and calculates a plus offset value with respect with such a base station having a small fading deterioration. In other words, even when a distance between the own terminal and such a base station is short and reception level is high, the handover control unit 120 applies the offset value along the minus direction to a reception level of the base station in which the reception level is easily fluctuated by the fading phenomenon, whereas even when a reception level is low, the handover control unit 120 applies the offset value along the plus direction to a reception level of such a base station that a condition as a communication route is better. As a consequence, the handover control unit 120 deletes such a base station which does not preferably constitute a desirable base station of a handover destination from handover candidates, and can readily select such a base station whose communication route is set to a better condition, so that a communication operation can be established between the own terminal and the base station whose communication route is set to the better condition in order that out of synchronous state does not occur, and a line interruption does not occur.

The handover destination selecting unit 126 selects such a base station which may constitute an optimum handover destination based upon both offset values calculated as to the plural peripheral base stations, and also, reception signal levels as to the plural peripheral base stations.

Next, operations of the mobile communication terminal according to this embodiment mode will now be described. While a mobile communication terminal is communicated to a plurality of base stations located at a peripheral area of this mobile communication terminal, or is operated under waiting state, the respective base stations transmit wireless signals. In the mobile communication terminal, when the wireless signals transmitted from the base stations are received by the wireless unit 100, the baseband processing unit 110 converts the reception signals into demodulated data having predetermined formats. At this time, the baseband processing unit 110 records a reception level and a path number of multipath with respect to each of the plurality of peripheral base stations on the reception level recording unit 133 of the recording unit 130 every base station. In this connection, FIG. 2 is a diagram for indicating an example of information recorded on the reception level recording unit 133. As indicated in this drawing, a plurality of reception levels are recorded at the latest time instant.

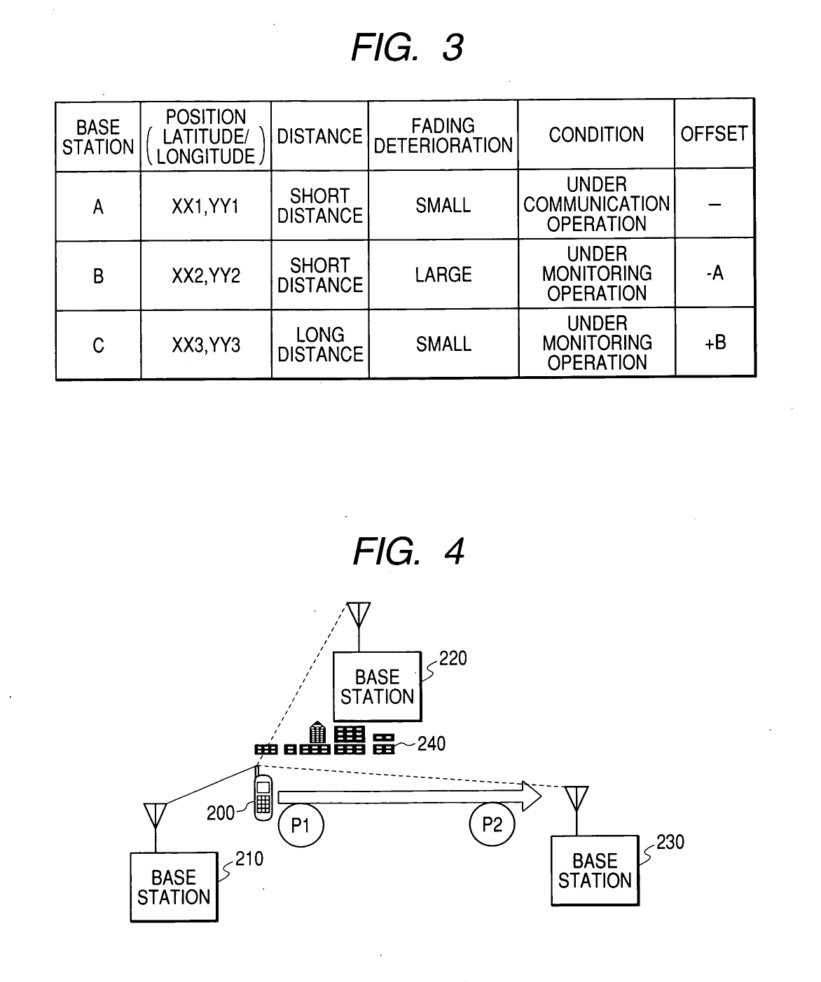

The positional information detecting unit 121 of the handover control unit 120 receives notification information via the wireless unit 100, which is transmitted from the plurality of peripheral base stations every time a predetermined time period has passed, and acquires positional information of the peripheral base stations, and then, records the acquired positional information via the baseband processing unit 110 on the peripheral base station information recording unit 131. In this case, the positional information detecting unit 121 does not acquire positional information as to all of the peripheral base stations, but acquires positional information as to such base stations from which the notification information could be received. After the process operation for acquiring the positional information of the peripheral base stations has been carried out, the positional information detecting unit 121 of the handover control unit 120 detects a position of the own mobile communication terminal based upon the positional information of the base stations from which the notification information could be received among these peripheral base stations. Then, the positional information detecting unit 121 records the detected position of the own terminal via the baseband processing unit 110 on the mobile machine positional information recording unit 132. In this case, FIG. 3 is a diagram for indicating an example of such information which is recorded on the peripheral base station information recording unit 131. In this drawing, positions (XX1, YY1, XX2, YY2, XX3, YY3) of peripheral base stations A to C; distances (short distance, short distance, long distance) between the own terminal and the peripheral base stations A to C; conditions (small, large, small) of fading deteriorations indicative of transfer path quantities; and offset values (−, −A, +B) have been recorded.

Since the positional information is recorded on the mobile machine positional information recording unit 132 every time the predetermined time period has passed, the move speed calculating unit 122 calculates a move speed of the own terminal based upon a temporal change of distances of the own terminal. Also, the move direction and move speed calculating unit 123 calculates a move direction based upon the temporal change of the distances of the own terminal. On the other hand, since the reception level data for plural sets of time instants have been stored in the reception level recording unit 133, the transfer path quality detecting unit 124 calculates dispersion of the reception levels of the wireless signals transmitted from the peripheral base stations based upon the stored reception level data, and furthermore, sets a condition of a fading deterioration based upon the dispersion of the reception level and the path number of the multipath.

When various sorts of parameters such as the move direction of the own terminal, the move speed thereof, the distances between the own terminal and the plurality of the peripheral base stations, and the conditions of the fading deteriorations in the plurality of the peripheral base stations have been acquired, the offset calculating unit 125 calculates offset values with respect to the reception levels every base station. Concretely speaking, in the case that such a base station is located along the move direction of the mobile communication terminal, the offset calculating unit 125 corrects an offset value along the plus direction. In the case that such a base station is located along a direction different from the move direction of the mobile communication terminal, the offset calculating unit 125 corrects an offset value along the minus direction. Also, the offset calculating unit 125 separates a parameter of a fading deterioration every threshold value in such a manner that when a fading deterioration is large, the offset value calculating unit 125 further corrects an offset value along the minus direction, whereas when a fading deterioration is small, the offset value calculating unit 125 further corrects an offset value along the plus direction. Then, the offset calculating unit 125 further adds this resultant value as the offset value.

Then, the handover destination selecting unit 126 selects such a base station which constitutes a handover destination based upon the offset values which have been calculated every a plurality of the peripheral base stations, and also, the reception signal levels detected every a plurality of the peripheral base stations.

Next, a description of operations in the case that the mobile communication terminal according to this embodiment mode is employed in a wireless communication system. FIG. 4 is a block diagram for indicating this wireless communication system.

In this drawing, it is so assumed that three sets of base stations 210, 220, and 230 are arranged, and a mobile terminal 200 is being moved form a point “P1” to another point “P2.” Also, an interference article 240 is present between the base station 220 and the mobile communication terminal 200. While mobile communication terminal 200 which is being moved at the point “P1” is communicated to the base station 210, both the base station 220 and the base station 230 are operated under monitoring condition that the base stations 220 and 2.30 receive downstream signals.

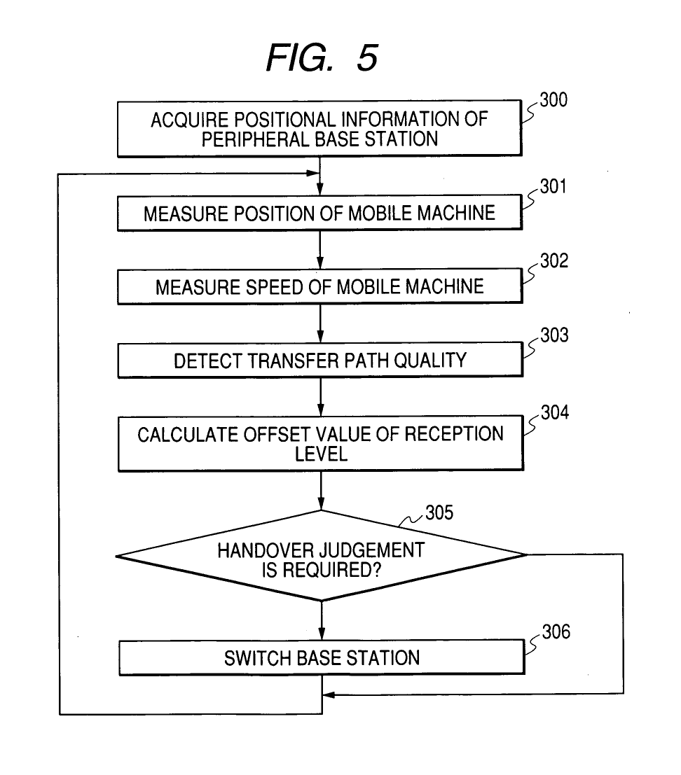

FIG. 5 is a flow chart for indicating operations of the mobile communication terminal 200 in the wireless communication system. While the mobile communication terminal 200: is communicated to the base station 210, this mobile communication terminal 200 acquires positional information as notification information transmitted from the peripheral base stations 210, 220, 230 at arbitrary timing, and then records there on the acquired positional information (step 300). Also, the mobile communication terminal 200 receives wireless signals transmitted from the peripheral base stations 210, 220, 230 every time a predetermined time period has passed, and then records thereon reception levels of these wireless signals.

The mobile communication terminal 200 detects the own position based upon both the positional information of the received peripheral base stations 210, 220, 230, and also, the positional information of the base station which is presently detected (step 301). Next, the mobile communication terminal 200 calculates both a move speed and a move direction based upon a change in the own positions which are now being recorded every time (step 302). Next, the mobile communication terminal 200 calculates dispersion of reception levels based upon measurement values of reception levels which have been acquired plural times in the past with respect to each of these base stations, and then judges a transfer path quality caused by the fading phenomenon based upon this calculated dispersion and the path number of the multipath (step 303).

Subsequently, the mobile communication terminal 200 sets offset values of reception levels with respect to each of the base stations 210, 220, and 230 from the various sorts of parameters such as the distances between the own mobile communication terminal 200 and each of the peripheral base stations 210, 220, 230; the move direction and the move speed of the own mobile communication terminal 200; and the conditions of the fading deteriorations (step 304). In other words, in such a case that the own mobile communication terminal 200 is now moved from the position P1 toward the position p2, even if a distance between the own terminal 200 and the base station 220 is short and a reception level is high, since a fluctuation of reception levels may occur due to a fading phenomenon caused by buildings, the mobile communication terminal 200 sets a priority degree to a low priority degree as the handover candidates with respect to this base station 220 and sets a minus value as an offset value. Conversely, even if a distance between the own terminal 200 and the base station 230 is long and a reception level is low, since an adverse influence of a fading phenomenon is low, the mobile communication terminal 200 sets a priority degree of the base station 230 located along the move direction of this mobile communication terminal 200 to a high priority degree and sets a plus value as an offset value.

Then, the mobile communication terminal 200 compares the handover threshold value which has been calculated based upon the reception level of the base station 210 under communication condition with a reception level of a peripheral base station+an offset value (step 305). In such a case that a reception level of a peripheral base station+an offset value is larger than the handover threshold value, the mobile communication terminal 200 performs an handover control operation for the peripheral base station (step 306). After the handover control operation has been carried out, the process operation is returned to the previous step 301. To the contrary, in such a case that a reception level of a peripheral base station+an offset value is smaller than the handover threshold value, the handover control operation is not carried out, and the control operation is directly returned to the step 301.

As previously explained, in accordance with the mobile communication terminal of this embodiment, the distances between the mobile communication terminal and the respective plural peripheral base stations, both the move direction and the move speed of this mobile communication terminal are calculated by the positional information detecting unit 121, the distance calculating unit 122, and the move direction and move speed calculating unit 123. Furthermore, the conditions of the fading deteriorations are acquired by the transfer path quality detecting unit 124. Then, based upon the acquired various sorts of parameters, the offset calculating unit 125 calculates the offset value with respect to the reception signal level every base station. Then, based upon both the offset value calculated every each of the plural peripheral base stations and the reception signal level every each of the plural peripheral base stations, the handover destination selecting unit 126 selects such a base station which constitutes the handover destination. As a result, a total number of the unnecessary handover control operations can be reduced, as compared with the conventional handover control system in which there are many possibilities that the base station located close to the mobile communication terminal is always selected. Eventually, the power saving effect of the mobile communication terminal can be achieved, and further, the load given to the entire wireless communication system can be reduced.

Also, in accordance with the mobile communication terminal of this embodiment mode, since the minus offset value is applied to the reception level of such a base station that the rapid change in the reception level of the reception signal may easily occur which is caused by the fading phenomenon, it is possible that this base station is not selected as the handover destination. Also, since the plus offset value is applied to the reception level of such a base station that the rapid change in the reception level of the reception signal can hardly occur which is caused by the fading phenomenon, it is possible to control that this base station can be selected as the handover destination with a top priority.

In accordance with the present invention, since the handover control operation is carried out based upon the distances between the own mobile communication terminal and the respective plural peripheral base stations, the transfer path qualities between the own mobile communication terminals, and both the move direction and the speed of the own mobile communication terminal, a total number of the unnecessary handover control operations can be reduced. As a consequence, the power consumption of the mobile communication terminal can be reduced, and the load given to the entire wireless communication system can be reduced, so that the communication operation can be maintained under stable condition.

Also, in accordance with the present invention, since the base station, the transfer path quality of which is high, is selected with a top priority, the rapid deterioration of the reception level of the wireless signal transmitted from the base station under communication can be prevented, so that the occurrences of out of the synchronous state and of the line interruption with respect to the base station can be reduced.

### Translation of Drawings

FIG. 1

100 wireless unit;
110 baseband processing unit;
120 handover control unit;
121 positional information detecting unit;
122 distance calculating unit;
123 move direction and move speed calculating unit;
124 transfer path quality detecting unit;
125 offset calculating unit;
126 overhand destination selecting unit;
130 recording unit;
131 peripheral base station information recording unit;
132 mobile machine positional information recording unit;
133 reception level recording unit;
   FIG. 2.
1 reception level;
2 time instant;
3 base station A;
4 base station B:
5 base station C;
   FIG. 3
1 base station;
2 position (latitude/longitude);
3 distance;
4 fading deterioration;
5 condition;
6 offset;
7 short distance;
8 long distance;
9 small;
10 large;
11 under communication operation;
12 under monitoring operation;
   FIG. 4
210, 220, 230, . . . base station;
   FIG. 5
STEPS:
300 acquire positional information of peripheral base station;
301 measure position of mobile machine;
302 measure speed of mobile machine;
303 detect transfer path quality;
304 calculate offset value of reception level;
305 handover judgement is required?;
306 switch base station;

1. A mobile communication terminal for communicating via wireless communication lines with respect to a plurality of base stations located at peripheral areas of the own mobile communication terminal, comprising:
a positional information detector, which acquires positional information of a peripheral base station operated under connection condition so as to detect a position of the own terminal;
a distance calculator, which calculates a distance between the position of the own terminal and each of the plural base stations;
a move direction and move speed detector, which detects both a move direction and a move speed of the own terminal based upon the positional information of the own terminal;
a transfer path quality detector, which detects a transfer path quality between the own terminal and each of the plural base stations;
a offset calculator, which calculates an offset value for a reception signal level with respect to each of the plural base stations based upon the distance between the own terminal and each of the plural base stations, and both the move direction and the move speed of the own terminal and also the transfer path quality; and
a handover destination selector, which selects a base station which constitutes a handover destination based upon the offset values calculated every the base station and the reception signal level every the base station.

2. The mobile communication terminal as claimed in claim 1 wherein:
the positional information detector detects the position of the own terminal based upon latitude and longitude information transmitted from the base station.

3. A mobile communication terminal as claimed in claim 1, wherein:
the move direction and move speed detector calculates both the move speed and the move direction of the own terminal based upon a ratio of temporal changes to the position of the own terminal calculated by the positional information calculator.

4. The mobile communication terminal as claimed in claim 1, wherein:
the transfer path quality detector detects the transfer path quality from a degree of fading deteriorations which is calculated based upon dispersion of a reception signal and a path number by multipath when the wireless signal transmitted from the base station is received.

5. The mobile communication terminal as claimed in claim 4 wherein:
the offset calculator calculates a minus offset value with respect to such a base station that a fading deterioration thereof is large.

6. The mobile communication terminal as claimed in claim 4 wherein:
the offset calculator calculates a minus offset value with respect to such a base station that a fading deterioration thereof is small.

7. The mobile communication terminal as claimed in claim 1, wherein:
the handover destination selector selects the base station which constitutes the handover destination based upon the offset values which have been set to the respective base stations and the reception signal levels of the wireless signals transmitted from the base stations.

8. A handover control method in which while a mobile communication terminal is moved among plural base stations, an optimum base station for communication operation is successively selected in connection with the movement of the mobile communication terminal, comprising:
a positional information detecting step for acquiring positional information of a peripheral base station operated under connection condition with the mobile communication terminal so as to detect a position of the mobile communication terminal;
a distance calculating step for calculating a distance between the position of the mobile communication terminal and each of the plural base stations;
a move direction and move speed detecting step for detecting both a move direction and a move speed of the mobile communication terminal based upon the positional information of the mobile communication terminal;
a transfer path quality detecting step for detecting a transfer path quality between the mobile communication terminal and each of the plural base stations;
an offset calculating step for calculating an offset value with respect to a reception signal level with respect to each of the plural base stations based upon the distance between the mobile communication terminal and each of the plural base stations, and both the move direction and the move speed of the mobile communication terminal and also the transfer path quality; and
a handover destination selecting step for selecting a base station which constitutes a handover destination based upon the offset values calculated every the base station and the reception signal level every the base station.

9. A handover control program in which while a mobile communication terminal is moved among plural base stations, an optimum base station for communication operation is successively selected in connection with the movement of the mobile communication terminal, wherein:
the handover control program causes a computer to execute:
a positional information detecting step for acquiring positional information of a peripheral base station operated under connection condition with the mobile communication terminal so as to detect a position of the mobile communication terminal;
a distance calculating step for calculating a distance between the position of the mobile communication terminal and each of the plural base stations;
a move direction and move speed detecting step for detecting both a move direction and a move speed of the mobile communication terminal based upon the positional information of the mobile communication terminal;
a transfer path quality detecting step for detecting a transfer path quality between the mobile communication terminal and each of the plural base stations;
an offset calculating step for calculating an offset value with respect to a reception signal level with respect to each of the plural base stations based upon the distance between the mobile communication terminal and each of the plural base stations, and both the move direction and the move speed of the mobile communication terminal and also the transfer path quality; and
a handover destination selecting step for selecting a base station which constitutes a handover destination based upon the offset values calculated every the base station and the reception signal level every the base station.
